(19) United States
(12) Patent Application Publication
(10) Pub. No.: US 2025/0200424 A1
(43) Pub. Date: Jun. 19, 2025

(54) DYNAMIC CONFIGURATION OF A DATA PROCESSING SYSTEM

(71) Applicant: Capital One Services, LLC, McLean, VA (US)

(72) Inventors: Ajit DHOBALE, Fremont, CA (US); Collin Michael MCFADDEN, Eden Prairie, MN (US)

(21) Appl. No.: 18/540,334

(22) Filed: Dec. 14, 2023

(51) Int. Cl. G06N 20/00

(52) U.S. Cl. CPC G06N 20/00

(57) ABSTRACT

In some implementations, a data processing system may identify one or more real-time data parameters associated with a data stream. The data processing device may determine, using at least one of a machine learning model or a set of rules, and based on the real-time data parameters, a set of optimal processing parameters associated with processing the data stream. The data processing system may configure a data processing device with the set of optimal processing parameters. The data processing device may process the data stream using the data processing device and based on the set of optimal processing parameters.

### BACKGROUND

Large streams of data may need to be processed in order to be used by a user or an application, among other examples. Streams of data may be processed in real-time (sometimes referred to a stream processing) or in batches (sometimes referred to as batch processing). Stream processing may enable use of individual events as soon as events are available while batch processing may reduce resource consumption by applying data transformations to many events at once.

### SUMMARY

Some implementations described herein relate to a system for dynamically configuring processing parameters for streaming data. The system may include one or more memories and one or more processors communicatively coupled to the one or more memories. The one or more processors may be configured to train a machine learning model based on multiple sets of processing parameters and one or more data parameters associated with the multiple sets of processing parameters. The one or more processors may be configured to identify one or more real-time data parameters associated with a data stream. The one or more processors may be configured to identify, using the machine learning model and based on the real-time data parameters, a set of optimal processing parameters associated with processing the data stream. The one or more processors may be configured to configure a data processing device with the set of optimal processing parameters. The one or more processors may be configured to process the data stream using the data processing device and based on the set of optimal processing parameters.

Some implementations described herein relate to a method of dynamically configuring a data processing system. The method may include identifying one or more real-time data parameters associated with a data stream. The method may include determining, using at least one of a machine learning model or a set of rules, and based on the real-time data parameters, a set of optimal processing parameters associated with processing the data stream. The method may include configuring a data processing device with the set of optimal processing parameters. The method may include processing the data stream using the data processing device and based on the set of optimal processing parameters.

Some implementations described herein relate to a non-transitory computer-readable medium that stores a set of instructions. The set of instructions, when executed by one or more processors of a data processing device, may cause the data processing device to identify one or more real-time data parameters associated with a data stream. The set of instructions, when executed by one or more processors of the data processing device, may cause the data processing device to determine, using at least one of a machine learning model or a set of rules, and based on the real-time data parameters, a set of optimal processing parameters associated with processing the data stream. The set of instructions, when executed by one or more processors of the data processing device, may cause the data processing device to configure the data processing device with the set of optimal processing parameters. The set of instructions, when executed by one or more processors of the data processing device, may cause the data processing device to process the data stream based on the set of optimal processing parameters.

### BRIEF DESCRIPTION OF THE DRAWINGS

FIGS. 1A-1F are diagrams of an example associated with dynamic configuration of a data processing system, in accordance with some embodiments of the present disclosure.

FIG. 2 is a diagram illustrating an example of training and using a machine learning model in connection with dynamic configuration of a data processing system, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with dynamic configuration of a data processing system, in accordance with some embodiments of the present disclosure.

FIG. 5 is a flowchart of an example process associated with dynamic configuration of a data processing system, in accordance with some embodiments of the present disclosure.

### DETAILED DESCRIPTION

The following detailed description of example implementations refers to the accompanying drawings. The same reference numbers in different drawings may identify the same or similar elements.

Vast amounts of data may be stored electronically in data structures (e.g., databases, blockchains, log files, cookies, or the like). A device may perform multiple queries, or other information retrieval techniques, to unrelated data structures to obtain data relevant to a particular task or computational operation. Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to achieve desired computational outcomes or automation outcomes, thereby expending significant computing resources (e.g., processor resources and/or memory resources) and causing significant delays.

In addition, many real-time processes require large amounts of data on backend systems to improve customer experiences. For example, streams containing customer events may be analyzed in real-time to detect fraudulent use of customer accounts, among other examples. Additionally, streams containing customer events may be used to message a customer about actions that have occurred on the customer's account, such that an application that messages the customer is decoupled from the core process that completes the action. These stream-based applications make use of the real-time data in milliseconds to create additional decisions, data transformations, and customer communications. As such, stream-based applications may need to be cost effective and quick to scale.

Some implementations described herein enable integration of otherwise incompatible data from multiple unrelated data structures. In some implementations, a system may use a machine learning model to predict a set of optimal processing parameters for processing a data stream. For example, the machine learning model may determine the set of optimal processing parameters based on data relating to real-time data parameters associated with the data stream, such as a size of the data stream, a data type associated with the data stream, a time of day and/or week associated with the data stream, or similar parameters. Based on the set of optimal processing parameters, the system may configure a data processing device to process the data stream.

In this way, the machine learning model enables the system to perform operations based on otherwise incompatible data while conserving computing resources and reducing delays that would otherwise result from separate handling of the data using complex instructions and/or repetitive processing. Moreover, an output of the machine learning model may convey data from the multiple unrelated databases in a smaller user interface or in a lesser number of user interfaces than otherwise would have been used to individually present data from the multiple unrelated databases. In this way, the use of computing resources and network resources is reduced in connection with processing streams of data, detecting fraudulent use of customer accounts, or messaging customers about certain actions, among other examples.

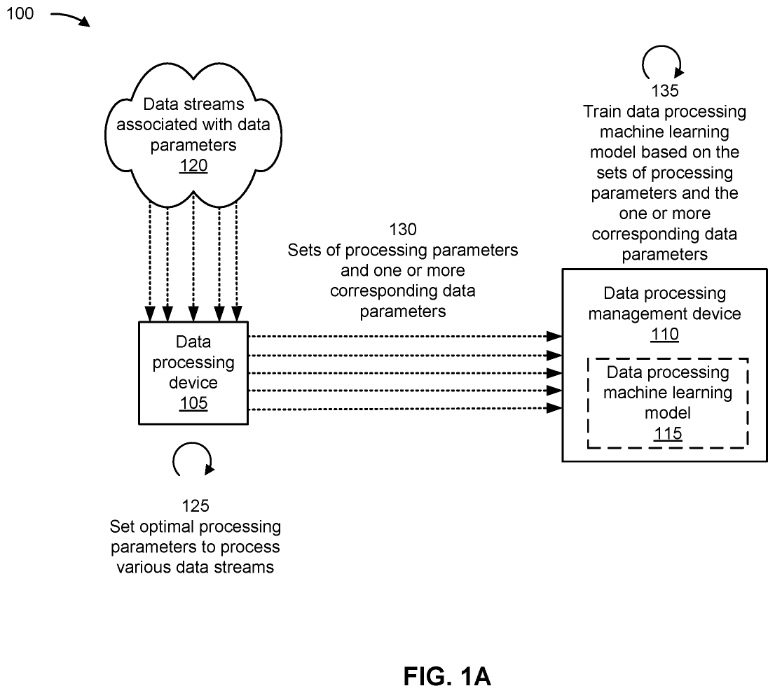

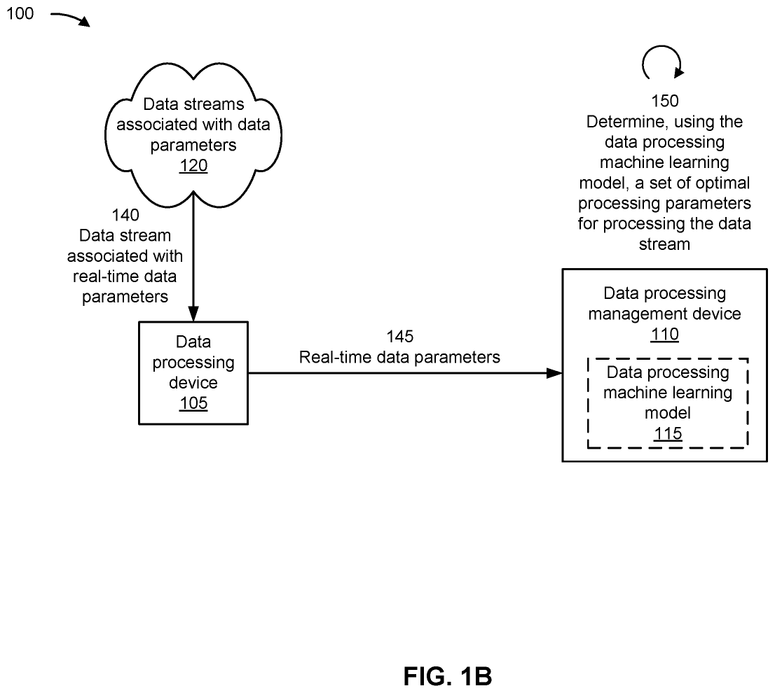

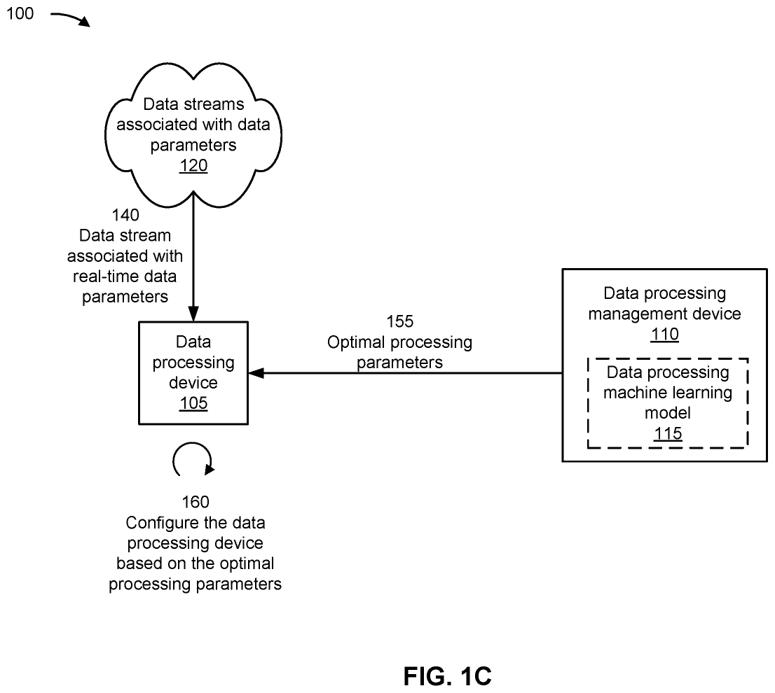

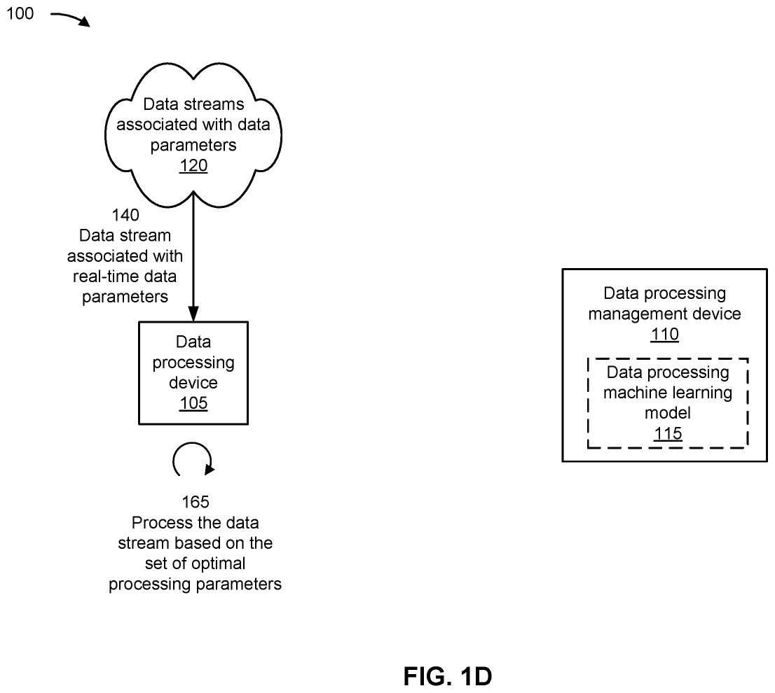

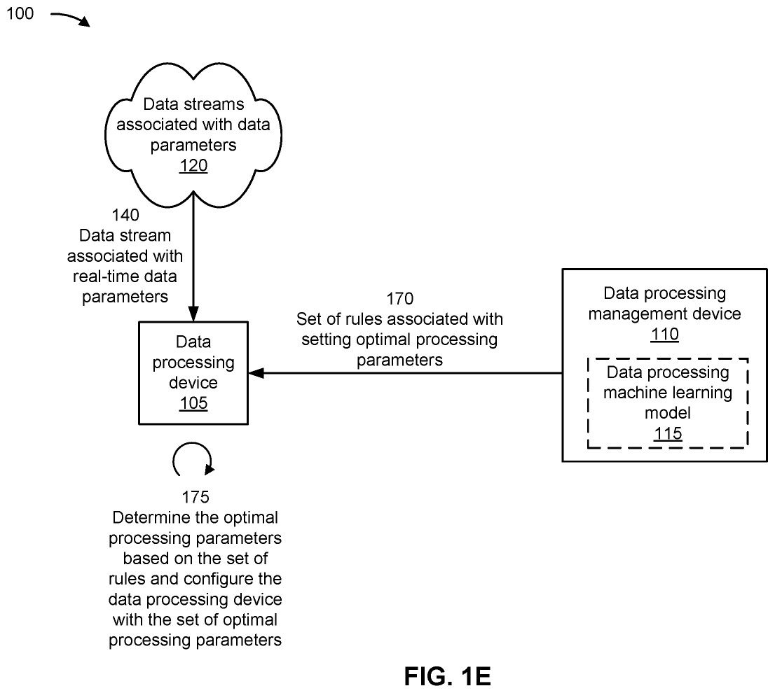

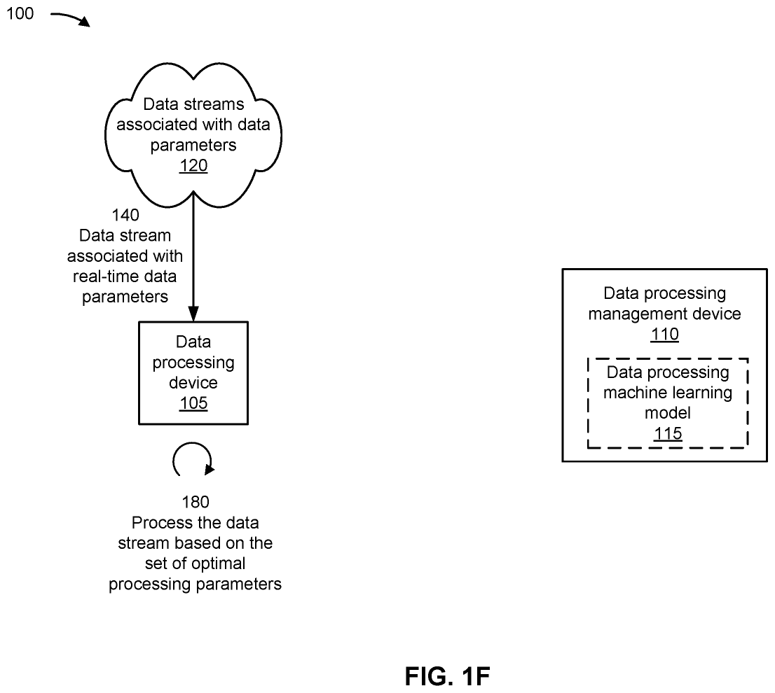

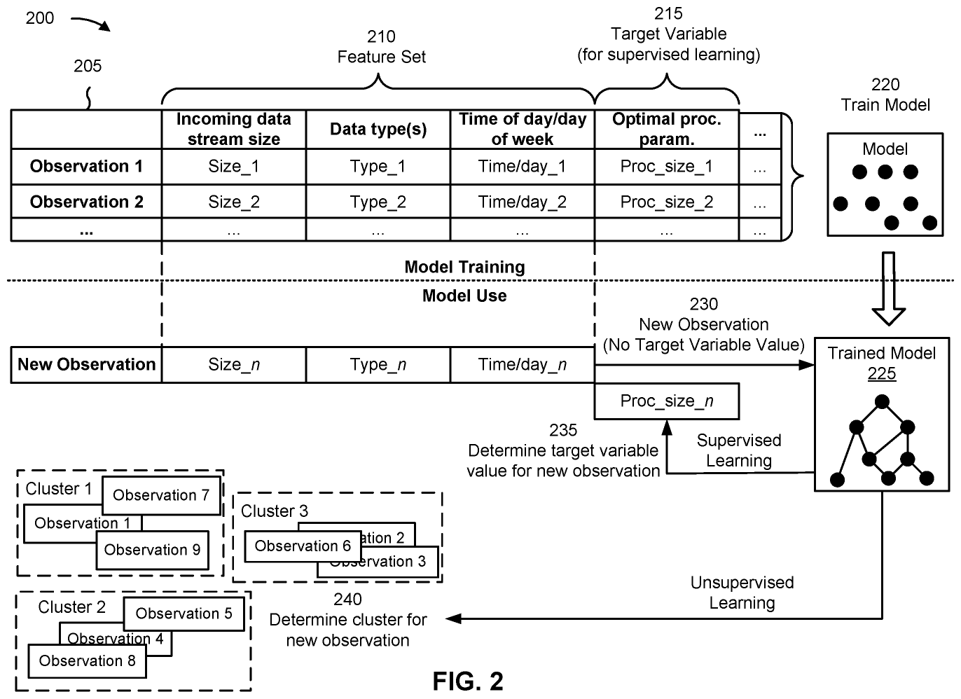

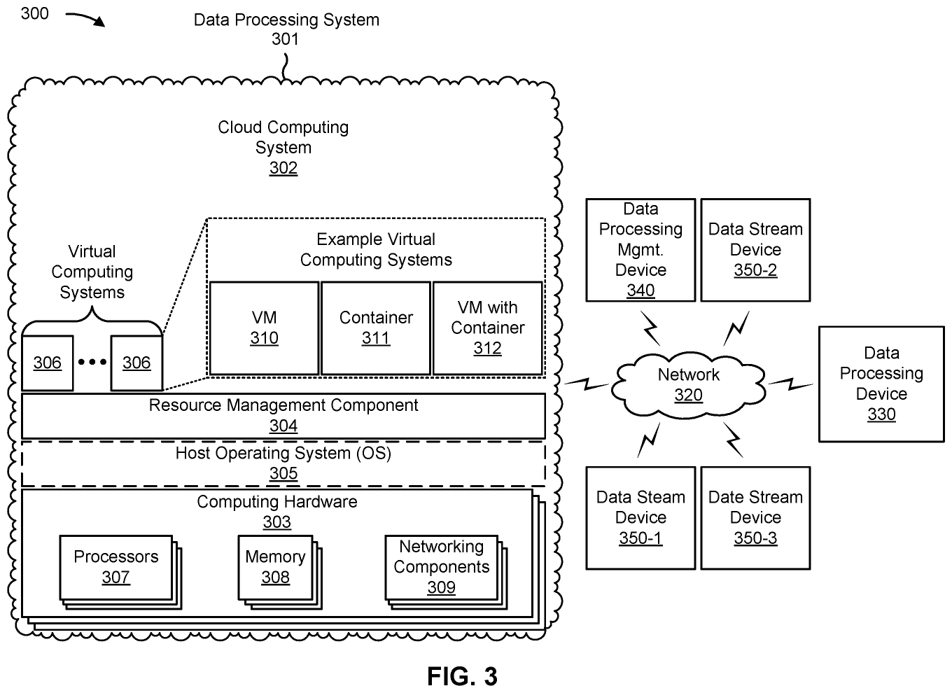

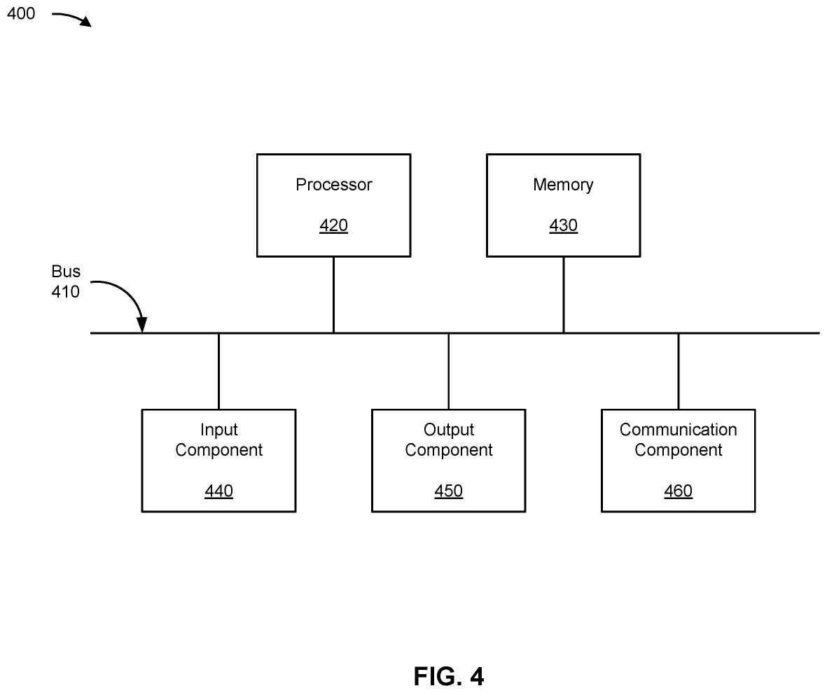

FIGS. 1A-1F are diagrams of an example 100 associated with dynamic configuration of a data processing system. As shown in FIGS. 1A-1F, example 100 includes a data processing device 105 and a data processing management device 110. In some implementations, the data processing management device 110 may include, or may otherwise be associated with, a data processing machine learning model 115. The data processing device 105 and the data processing management device 110 are described in more detail in connection with FIGS. 3 and 4. The data processing machine learning model 115 is described in more detail in connection with FIG. 2.

As shown in FIG. 1A, and as indicated by reference number 120, the data processing device 105 may be configured to receive and process streaming data. More particularly, the data processing device 105 may be configured to receive multiple data streams (sometimes referred to simply as “streams,” collectively, or a “stream,” individually, herein), with each of the data streams associated with certain data parameters. For example, a data stream may be associated with an incoming stream size parameter, which may indicate a size of the data stream. Additionally, or alternatively, a data stream may be associated with a number of stream partitions parameter, which may indicate a number of partitions in the data stream. For example, a stream of data provided and/or managed by the data processing device 105 may also be referred to as a topic. Topics may be a stream of records (messages) and/or data that are organized into partitions. Each partition may be a sequence of ordered, immutable records that are written to and read from sequentially. This allows for parallel processing of the data in a topic by different consumers, while maintaining the order of the records within each partition. In such implementations, the number of stream partitions parameter may be associated with a quantity of partitions associated with the incoming data stream.

Additionally, or alternatively, a data stream may be associated with a data distribution among stream partitions parameter, which may indicate an uneven distribution of a total volume of messages between the stream partitions. More particularly, certain stream producers may designate partition keys to indicate which varieties of messages should go in each partition. In some implementations, designation of partition keys may result in some partitions including many more (e.g., two times or more) messages as compared to other partitions, and/or certain partitions may be left unused. In such implementations, the data distribution among stream partitions parameter may be associated with the relative distribution of the messages among the data stream partitions.

Additionally, or alternatively, a data stream may be associated with a publishing pattern parameter, which may indicate a publishing pattern of the data stream producer. For example, the publishing pattern parameter may be associated with whether data is contributed in real-time, whether data is contributed in periodic batches, whether data is contributed in a combination of real-time and periodic batches, or the like. Additionally, or alternatively, a data stream may be associated with a presence of consumer lag parameter, which may indicate whether a stream consumer is processing events immediately when they are available (e.g., no consumer lag is present) or whether a stream consumer is not processing events immediately when they are available (e.g., consumer lag is present).

Additionally, or alternatively, a data stream may be associated with a data type parameter, which may indicate one or more data types used in the streaming data. Additionally, or alternatively, a data stream may be associated with a stream characteristics parameter, which may indicate features of the data stream associated with peculiar (e.g., non-standard) stream characteristics. Additionally, or alternatively, a data stream may be associated with a type of application parameter, which may indicate a type of application that the data stream is being used for. Additionally, or alternatively, a data stream may be associated with a data processing latency parameter, which may indicate a latency of data processing, such as an indication of data processing latency associated with stream events being augmented with data from other application programming interfaces (APIs) (e.g., APIs separate from an API associated with the data processing device 105 and/or associated with an application that is relevant to the data processing device 105).

Additionally, or alternatively, a data stream may be associated with a central processing unit (CPU) and/or memory utilization for consumer nodes parameter, which may indicate a CPU and/or memory percent utilization by consumer nodes associated with the data stream. Similarly, a data stream may be associated with a CPU and/or memory utilization for processor nodes parameter, which may indicate a CPU and/or memory percent utilization by processor nodes associated with the data stream. Additionally, or alternatively, a data stream may be associated with a relevant percentage parameter, which may indicate a percentage of events in the data stream that are relevant to an application associated with the data processing device 105. Additionally, or alternatively, a data stream may be associated with a time of day parameter and/or a day of a week parameter, which may indicate a time of day and/or a day of a week, respectively, that the data stream is received at the data processing device 105.

As indicated by reference number 125, the data processing device 105 may be configured to set optimal processing parameters to process the various data streams received at the data processing device 105. More particularly, the various data streams may exhibit certain patterns of peaks and troughs, such as high volume during certain days of the week and/or times of the day. Accordingly, the data processing device 105 may be configured to change (e.g., reconfigure) and/or optimize certain processing parameters in order to achieve efficient processing of the data streams.

In some implementations, a set of processing parameters may be associated with a processing batch size parameter, which may correspond to a batch size used for data processing. Additionally, or alternatively, a set of processing parameters may be associated with an API batch size parameter, which may correspond to a batch size associated with calling other APIs (e.g., APIs separate from an API associated with the data processing device 105). Additionally, or alternatively, a set of processing parameters may be associated with a number of stream consumer nodes parameter, which may correspond to a number of stream consumer nodes associated with the data stream. Similarly, a set of processing parameters may be associated with a number of stream processor nodes parameter, which may correspond to a number of stream processor nodes associated with the data stream. Additionally, or alternatively, a set of processing parameters may be associated with a number of parallel connections between consumer pods and processor pods parameter, which may correspond to a quantity of parallel connections between consumer pods and processor pods associated with the data stream.

Additionally, or alternatively, a set of processing parameters may be associated with a number of processor threads parameter, which may correspond to a number of processor threads associated with processing the data stream. Additionally, or alternatively, a set of processing parameters may be associated with a report monitoring metric granularity parameter, which may correspond to a granularity or monitoring certain metrics associated with data stream. More particularly, when monitoring data processing, thorough metric collection and reporting may result in a noticeable latency when working with high-throughput streams. Moreover, certain monitoring tools that enable sampling may be associated with a percentage of metric values to propagate to the upstream. However, when working with streams of varying sizes, there may be little performance impact from publishing 100% of metrics for small streams and/or there may be little value in publishing 100% of the metrics for large streams, particularly compared to the latency incurred from 100% publishing. Accordingly, in some implementations, a set of processing parameters may be associated with a report monitoring metric granularity parameter associated with a granularity (e.g., percentage) of metrics that are to be monitored and/or reported.

Additionally, or alternatively, a set of processing parameters may be associated with a commit after count parameter, which may correspond to a number of messages that are to be read from a partition before committing a Kafka offset (e.g., an offset associated with an Apache Kafka distributed streaming platform and/or a Kafka topic). Additionally, or alternatively, a set of processing parameters may be associated with a commit after time parameter, which may correspond to a time threshold (e.g., a number of second) after which a partition will commit an offset (e.g., a Kafka offset). Additionally, or alternatively, a set of processing parameters may be associated with a CPU and/or memory allocation for consumer nodes parameter, which may correspond to a CPU and/or memory percent allocation for use by consumer nodes associated with the data stream. Similarly, a set of processing parameters may be associated with a CPU and/or memory allocation for processor nodes parameter, which may correspond to a CPU and/or memory percent allocation for use by processor nodes associated with the data stream.

In some implementations, reconfiguring the set of processing parameters for each data stream (e.g., based on the data parameters associated with each data stream) may be time and/or resource intensive. Accordingly, in some implementations, a machine learning model may be trained based on historical sets of data parameters and/or processing parameters, and/or the machine learning model may be used to predict optimal processing parameters associated with an incoming data stream, thereby conserving computing resources and reducing delays that would otherwise result from separate handling of the data using complex instructions and/or repetitive processing.

More particularly, as shown by reference number 130, in some implementations the data processing device 105 may provide, to the data processing management device 110, various data sets associated with processing data streams at the data processing device. More particularly, the data processing device 105 may provide, to the data processing management device 110, various sets of processing parameters used to process data streams and the corresponding data parameters associated with the processed data streams. In this way, a supervised machine learning model associated with the data processing management device 110 (e.g., the data processing machine learning model 115) may learn the various configurations, given the incoming stream size, data types, time of the day, day of the week, and similar data parameters, and/or the machine learning model may make a prediction on the ideal configuration for optimally processing a given data stream, in real-time, resulting in dynamic changes to the stream processing configuration.

More particularly, as indicated by reference number 135, the data processing management device 110 may be configured to train the data processing machine learning model 115 based on multiple sets of processing parameters and one or more data parameters associated with the multiple sets of processing parameters (e.g., the sets of processing parameters and one or more corresponding data parameters described above in connection with reference number 130). In some implementations, the data processing machine learning model 115 may be associated with one of a multi-class machine learning model or a multi-label machine learning model.

For example, the data processing machine learning model 115 may be associated with a supervised machine learning model associated with a multi-class classification, such as a machine learning model associated with a decision tree model, a machine learning model associated with a random forest model, a machine learning model associated with an XGBoost model, a machine learning model associated with one or more neural networks, or the like. In such implementations, the data processing machine learning model 115 may be configured to predict a single processing parameter at a time, given the various data parameters as inputs. In some other implementations, the data processing machine learning model 115 may be associated with a multi-label classification model, such as a machine learning model capable of predicting different combinations of processing parameters given the various data parameters as inputs. In such implementations, the data processing machine learning model 115 may be configured to predict multiple processing parameters at a time, given the various data parameters as inputs. Additionally, or alternatively, in some implementations the data processing machine learning model 115 may be associated with a deep learning model. Additional aspects of an example data processing machine learning model 115 are described in more detail below in connection with FIG. 2.

In some implementations, in connection with the operations shown and described in connection with reference number 135, one or more parameters may be curated and/or weighted when training the data processing machine learning model 115. For example, in some implementations, the sets of processing parameters used to train the data processing machine learning model 115 and/or the one or more data parameters used to train the data processing machine learning model 115 may be associated with curated data. “Curated data” refers to data for which optimal usage of parameters and infrastructure (e.g., cloud resources, which are described in more detail below in connection with FIG. 3) has occurred in the past. In such implementations, the data processing device 105 and/or the data processing management device 110 may further be configured to curate the data (e.g., the sets of processing parameters and/or the one or more corresponding data parameters) prior to training the data processing machine learning model 115. Additionally, or alternatively, in some implementations the sets of processing parameters used to train the data processing machine learning model 115 and/or the one or more data parameters used to train the data processing machine learning model 115 may be weighted based on a corresponding usage of infrastructure resources associated with the sets of processing parameters and/or the one or more data parameters. For example, percentage utilization of infrastructure resources (e.g., cloud resources) may be used as weights for training the data processing machine learning model 115.

As shown in FIG. 1B, in some implementations the data processing management device 110 may be configured to determine and/or predict optimal processing parameters for a data stream using the trained data processing machine learning model 115. More particularly, as indicated by reference number 140, the data processing device 105 may receive a data stream associated with real-time data parameters (e.g., data parameters associated with a stream received in real-time). As described above in connection with FIG. 1A, the real-time data parameters may include an incoming stream size parameter, a number of stream partitions parameter, a data distribution among stream partitions parameter, a publishing pattern parameter, a presence of consumer lag parameter, a data type parameter, a type of application parameter, a data processing latency parameter, a relevant percentage parameter, a CPU and/or memory utilization for consumer nodes parameter, a CPU and/or memory utilization for processor nodes parameter, a time of day parameter, a day of a week parameter, and/or a similar data parameter.

As indicated by reference number 145, the data processing device 105 may provide the one or more real-time data parameters associated with a data stream to the data processing management device 110. Put another way, in some implementations the data processing management device 110 may identify the one or more real-time data parameters, such as by receiving an indication of the real-time data parameters from the data processing device 105. Moreover, as indicated by reference number 150, the data processing management device 110 may determine a set of optimal processing parameters for processing the data stream. For example, the data processing management device 110 may determine the set of optimal processing parameters for processing the data stream using the data processing machine learning model 115 and based on the real-time data parameters (e.g., by using the real-time data parameters as input to the data processing machine learning model 115).

As shown in FIG. 1C, the data processing management device 110 may configure the data processing device 105 with the optimal processing parameters to optimally process the incoming data stream. More particularly, as shown by reference number 155, the data processing management device 110 may provide an indication of the optimal processing parameters to the data processing device 105. As described above in connection with FIG. 1A, the optimal processing parameters may include one or more of a processing batch size parameter, an API batch size parameter, a number of stream consumer nodes parameter, a number of stream processor nodes parameter, a number of parallel connections between consumer pods and processor pods parameter, a number of processor threads parameter, a report monitoring metric granularity parameter, a commit after count parameter, a commit after time parameter, a CPU and/or memory allocation for consumer nodes parameter, a CPU and/or memory allocation for processor nodes parameter, and/or a similar processing parameter. Moreover, as indicated by reference number 160, the data processing device 105 may be configured with the set of optimal processing parameters, such that the data processing device 105 may efficiently process the data stream with minimal time, power, computing, and network resource usage, or the like.

More particularly, as shown in FIG. 1D, and as indicated by reference number 165, the data processing device 105 may process the data stream based on the set of optimal processing parameters. For example, the data processing device 105 may process the data stream by utilizing an optimal batch size, an optimal API batch size, an optimal number of stream consumer nodes, an optimal number of stream processor nodes, an optimal number of parallel connections between consumer pods and processor pods, an optimal number of processor threads, an optimal report monitoring metric granularity, an optimal commit after count, an optimal commit after time, an optimal CPU and/or memory allocation for consumer nodes, an optimal CPU and/or memory allocation for processor nodes, and/or a similar optimal processing parameter.

Although the example described above in connection with FIGS. 1A-1D employs the data processing machine learning model to configure a data processing device 105 with optimal processing parameters in real-time, in some other implementations a data processing management system may utilize a rule-based configuration scheme instead, or in addition to, the machine-learning scheme described above. For example, a rules-based scheme may be used for the purposes of determining the optimal processing parameters, in which the data processing management device 110 creates a set of rules (e.g., based on the historical sets of processing parameters and/or the corresponding one or more data parameters, as described above in connection with reference number 130) that determine a set of optimal processing parameters for the data processing device 105 when setting up stream processing. In such implementations, the set of rules may indicate one or more processing parameters to be used based on attributes of the incoming data stream (e.g., the one or more real-time data parameters). Additionally, or alternatively, the data processing management device 110 may be capable of changing the rules dynamically based on performance evaluation, or the like. In some implementations, the data processing management device 110 may combine deep technical expertise with historic stream data characteristics (e.g., data parameters) and configuration parameters (e.g., processing parameters) to create such a rules-based system.

More particularly, as shown in FIG. 1E, and as indicated by reference number 170, the data processing management device 110 may indicate, to the data processing device 105, a set of rules associated with setting optimal processing parameters at the data processing device 105. In some implementations, the set of rules may indicate a corresponding set of processing parameters for each of multiple candidate sets of one or more data parameters. Accordingly, as indicated by reference number 175, the data processing device 105 may determine the optimal processing parameters for processing a data stream (e.g., the data stream described above in connection with reference number 140) based on the set of rules. More particularly, the data processing device 105 may determine, using the set of rules and based on the real-time data parameters associated with the data stream, a set of optimal processing parameters associated with processing the data stream, and/or the data processing device 105 may configure itself based on the set of optimal processing parameters. Accordingly, as shown in FIG. 1F, and as indicated by reference number 180, the data processing device 105 may process the data stream based on the set of optimal processing parameters.

Based on using a machine learning model (e.g., the data processing machine learning model 115) and/or a set of rules associated with historical data, the data processing device 105 may be configured with optimal processing parameters for processing an incoming data stream, resulting in more efficient data processing operations and thus reduced time, power, computing, and network resource consumption. More particularly, based on using a machine learning model and/or a set of rules associated with historical data, the data processing device 105 may be dynamically configured rather than being configured with a fixed set of data processing parameters, which may be suboptimal for different instances of the incoming data stream.

As indicated above, FIGS. 1A-1F are provided as an example. Other examples may differ from what is described with regard to FIGS. 1A-1F.

FIG. 2 is a diagram illustrating an example 200 of training and using a machine learning model in connection with dynamic configuration of a data processing system. The machine learning model training and usage described herein may be performed using a machine learning system. The machine learning system may include or may be included in a computing device, a server, a cloud computing environment, or the like, such as one or more devices or components of the data processing system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a data processing device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a data processing device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an incoming data stream size, a second feature of a data type, a third feature of a time of day and/or a day of a week, and so on. As shown, for a first observation, the first feature may have a value of size_1 (e.g., a quantity of megabytes, or the like), the second feature may have a value of type_1 (e.g., voice data, financial transactions, video data, or the like), the third feature may have a value of time/day_1 (e.g., Saturday at 7:00 pm), and so on. These features and feature values are provided as examples, and may differ in other examples. For example, the feature set may include one or more of the following features: an incoming stream size, a number of stream partitions, a data distribution among stream partitions, a publishing pattern, a presence of consumer lag, a data type, a type of application, a data processing latency, a relevant percentage, a CPU and/or memory utilization for consumer nodes, a CPU and/or memory utilization for processor nodes, a time of day, or a day of a week.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is an optimal processing parameter (e.g., stream processing size), which has a value of proc_size_1 (e.g., a number of transactions and/or events, or the like) for the first observation. This target variable is provided as an example, and may differ in other examples. For example, the target variable may include one or more of the following optimal processing parameters: a processing batch size parameter, an API batch size parameter, a number of stream consumer nodes parameter, a number of stream processor nodes parameter, a number of parallel connections between consumer pods and processor pods parameter, a number of processor threads parameter, a report monitoring metric granularity parameter, a commit after count parameter, a commit after time parameter, a CPU and/or memory allocation for consumer nodes parameter, or a CPU and/or memory allocation for processor nodes parameter.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical configurations associated with a data processing device, such as the data processing device 105 described above in connection with FIGS. 1A-1F. For example, as described above in connection with reference number 130, the data processing device 105 may provide the machine learning system with historical data that includes multiple sets of optimal processing parameters and corresponding one or more data parameters. The machine learning system may thus be trained to learn optimal processing parameters that are to be used based on certain attributes of an incoming data stream (e.g., the one or more real-time data parameters described above in connection with FIGS. 1A-1F).

As shown by reference number 230, the machine learning system may apply the trained machine learning model 225 to a new observation, such as by receiving a new observation and inputting the new observation to the trained machine learning model 225. As shown, the new observation may include a first feature of size_n, a second feature of type_n, a third feature of time/day_n, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of proc_size_n (e.g., a quantity of transactions and/or events) for the target variable of an optimal processing parameter for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, to configure a data processing device with one or more optimal processing parameters (e.g., one or more of an optimal batch size, an optimal API batch size, an optimal number of stream consumer nodes, an optimal number of stream processor nodes, an optimal number of parallel connections between consumer pods and processor pods, an optimal number of processor threads, an optimal report monitoring metric granularity, an optimal commit after count, an optimal commit after time, an optimal CPU and/or memory allocation for consumer nodes, an optimal CPU and/or memory allocation for processor nodes, and/or a similar optimal processing parameter). The first automated action may include, for example, configuring the data processing device with the one or more optimal processing parameters.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first grouping of real-time data parameters), then the machine learning system may provide a first recommendation, such as a recommendation to configure to a data processing device with a first set of processing parameters. Additionally, or alternatively, the machine learning system may perform a first automated action and/or may cause a first automated action to be performed (e.g., by instructing another device to perform the automated action) based on classifying the new observation in the first cluster, such as configuring the data processing device with the first set of processing parameters.

As another example, if the machine learning system were to classify the new observation in a second cluster (e.g., a second grouping of real-time data parameters), then the machine learning system may provide a second (e.g., different) recommendation (e.g., a recommendation to configure to the data processing device with a second set of processing parameters) and/or may perform or cause performance of a second (e.g., different) automated action, such as configuring the data processing device with the second set of processing parameters.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include one or more predicted optimal processing parameters for incoming data streams.

In this way, the machine learning system may apply a rigorous and automated process to identify optimal processing parameters for processing an incoming data stream. The machine learning system may enable recognition and/or identification of tens, hundreds, thousands, or millions of features and/or feature values for tens, hundreds, thousands, or millions of observations, thereby increasing accuracy and consistency and reducing delay associated with identifying optimal processing parameters for processing an incoming data stream relative to requiring computing resources to be allocated for tens, hundreds, or thousands of operators to manually identify optimal processing parameters for processing an incoming data stream using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a data processing system 301, which may include one or more elements of and/or may execute within a cloud computing system 302. The cloud computing system 302 may include one or more elements 303-312, as described in more detail below. As further shown in FIG. 3, environment 300 may include a network 320, a data processing device 330 (e.g., data processing device 105), a data processing management device 340 (e.g., data processing management device 110), and/or one or more data stream devices 350 (shown in FIG. 3 as data stream device 350-1 through data stream device 350-3). In some implementations, one or more of the devices shown as being external to the cloud computing system 302 may alternatively be internal to the cloud computing system. For example, the data processing device 330 and/or the data processing management device 340 may be associated with a virtual machine of the cloud computing system 302. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the data processing system 301 may include one or more elements 303-312 of the cloud computing system 302, may execute within the cloud computing system 302, and/or may be hosted within the cloud computing system 302, in some implementations, the data processing system 301 may not be cloud-based (e.g., may be implemented outside of a cloud computing system) or may be partially cloud-based. For example, the data processing system 301 may include one or more devices that are not part of the cloud computing system 302, such as device 400 of FIG. 4, which may include a standalone server or another type of computing device. The data processing system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data processing device 330 may include one or more devices capable of processing data, such as one or more devices capable of processing an incoming stream of data. In some implementations, the data processing device 330 may be associated with an application and/or an API, and/or the data processing device 330 may be configured to communicate with the different applications via respective APIs. Moreover, the data processing device 330 may be configured to communicate with the different applications in order to configure processing jobs, execute processing jobs, and/or receive error messages relating to processing jobs, among other examples.

The data processing management device 340 may include one or more devices capable of identifying one or more optimal processing parameters for configuring a data processing device (e.g., data processing device 330) to efficiently process an incoming data stream. In some implementations, the data processing management device 340 may include or otherwise be associated with a data processing machine learning model (e.g., data processing machine learning model 115) that is trained using historical processing parameters and corresponding data parameters, and/or that is capable of predicting an optimal set of processing parameters using one or more real-time data parameters as input. Additionally, or alternatively, the data processing management device 340 may be capable identifying, maintaining, and/or dynamically change one or more rules associated with selecting one or more optimal processing parameters based on one or more real-time data parameters.

The data stream devices 350 may include one or more data stream producers, such as one or more sources of incoming data streams to be received and processed by a data processing device (e.g., the data processing device 330). In some implementations, the data stream devices 350 may be associated with a corresponding application and/or API. Additionally, or alternatively, the data stream devices may be associated with a personal computer, tablet, mobile device, server, cloud computing environment, or similar device and/or environment for collecting data and/or streaming data to a data processing device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with dynamic configuration of a data processing system. The device 400 may correspond to the data processing device 105, the data processing device 330, the data processing management device 110, the data processing management device 340, the data steam device 350, and/or any device and/or component described above as being associated with the cloud computing system 302. In some implementations, the data processing device 105, the data processing device 330, the data processing management device 110, the data processing management device 340, the data steam device 350, and/or any device and/or component described above as being associated with the cloud computing system 302 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

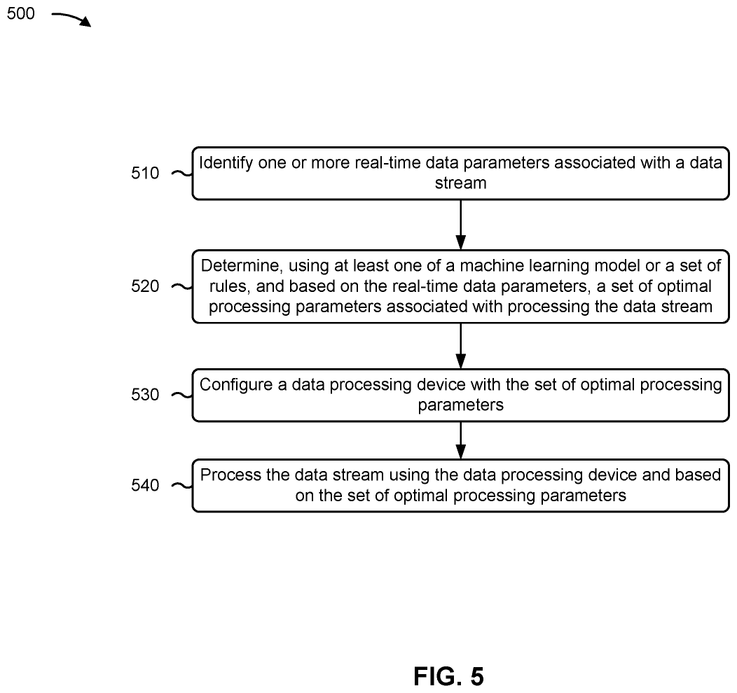

FIG. 5 is a flowchart of an example process 500 associated with dynamic configuration of a data processing system. In some implementations, one or more process blocks of FIG. 5 may be performed by the data processing system 301. In some implementations, one or more process blocks of FIG. 5 may be performed by another device or a group of devices separate from or including the data processing system 301, such as the data processing device 105, the data processing device 330, the data processing management device 110, the data processing management device 340, the data steam device 350, and/or any device and/or component described above as being associated with the cloud computing system 302. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include identifying one or more real-time data parameters associated with a data stream (block 510). For example, the data processing system 301 (e.g., using processor 420 and/or memory 430) may identify one or more real-time data parameters associated with a data stream, as described above in connection with reference number 145 of FIG. 1B. As an example, a data processing management device (e.g., the data processing management device 110) may receive, from a data processing device (e.g., data processing device 105) and indication of attributes associated with an incoming data stream, such as an incoming stream size, a number of stream partitions, a data distribution among stream partitions, a publishing pattern, a presence of consumer lag, a data type, a type of application, a data processing latency, a relevant percentage, a CPU and/or memory utilization for consumer nodes, a CPU and/or memory utilization for processor nodes, a time of day parameter, a day of a week, and/or a similar attribute.

As further shown in FIG. 5, process 500 may include determining, using at least one of a machine learning model or a set of rules, and based on the real-time data parameters, a set of optimal processing parameters associated with processing the data stream (block 520). For example, the data processing system 301 (e.g., using processor 420 and/or memory 430) may determine, using at least one of a machine learning model or a set of rules, and based on the real-time data parameters, a set of optimal processing parameters associated with processing the data stream, as described above in connection with reference number 150 of FIG. 1B and reference number 175 of FIG. 1E. As an example, the data processing management device 110 may determine, using a machine learning model (e.g., the data processing machine learning model 115), one or more processing parameters for processing an incoming data stream using one or more attributes of the incoming data stream as inputs to the machine learning model. As another example, the data processing device 105 may identify one or more processing parameters for processing an incoming data stream based one a set of rules indicated by the data processing management device 110.

As further shown in FIG. 5, process 500 may include configuring a data processing device with the set of optimal processing parameters (block 530). For example, the data processing system 301 (e.g., using processor 420 and/or memory 430) may configure a data processing device with the set of optimal processing parameters, as described above in connection with reference number 160 of FIG. 1C and reference number 175 of FIG. 1E. As an example, based on the output of the machine learning model and/or the set of rules, the data processing device 105 may be configured with an optimal batch size, an optimal API batch size, an optimal number of stream consumer nodes, an optimal number of stream processor nodes, an optimal number of parallel connections between consumer pods and processor pods, an optimal number of processor threads, an optimal report monitoring metric granularity, an optimal commit after count, an optimal commit after time, an optimal CPU and/or memory allocation for consumer nodes, an optimal CPU and/or memory allocation for processor nodes, and/or a similar optimal processing parameter.

As further shown in FIG. 5, process 500 may include processing the data stream using the data processing device and based on the set of optimal processing parameters (block 540). For example, the data processing system 301 (e.g., using processor 420 and/or memory 430) may process the data stream using the data processing device and based on the set of optimal processing parameters, as described above in connection with reference number 165 of FIG. 1D and reference number 180 of FIG. 1F. As an example, the data processing device 105 may process the incoming data stream described above in connection with reference number 140 after being configured with the optimal processing parameters for processing the stream.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamically configuring processing parameters for streaming data, the system comprising:
one or more memories; and
one or more processors, communicatively coupled to the one or more memories, configured to:
train a machine learning model based on multiple sets of processing parameters and one or more data parameters associated with the multiple sets of processing parameters;
identify one or more real-time data parameters associated with a data stream;
identify, using the machine learning model and based on the real-time data parameters, a set of optimal processing parameters associated with processing the data stream;
configure a data processing device with the set of optimal processing parameters; and
process the data stream using the data processing device and based on the set of optimal processing parameters.

2. The system of claim 1, wherein the one or more real-time data parameters includes one or more of:
an incoming stream size parameter,
a number of stream partitions parameter,
a data distribution among stream partitions parameter,
a publishing pattern parameter,
a presence of consumer lag parameter,
a data type parameter,
a type of application parameter,
a data processing latency parameter,
a relevant percentage parameter,
a central processing unit (CPU) and/or memory utilization for consumer nodes parameter,
a CPU and/or memory utilization for processor nodes parameter,
a time of day parameter, or
a day of a week parameter.

3. The system of claim 1, wherein the set of processing parameters includes one or more of:
a processing batch size parameter,
an application programming interface batch size parameter,
a number of stream consumer nodes parameter,
a number of stream processor nodes parameter,
a number of parallel connections between consumer pods and processor pods parameter,
a number of processor threads parameter,
a report monitoring metric granularity parameter,
a commit after count parameter,
a commit after time parameter,
a central processing unit (CPU) and/or memory allocation for consumer nodes parameter, or
a CPU and/or memory allocation for processor nodes parameter.

4. The system of claim 1, wherein the machine learning model is associated with one of a multi-class machine learning model or a multi-label machine learning model.

5. The system of claim 1, wherein at least one of the multiple sets of processing parameters or the one or more data parameters are associated with curated data.

6. The system of claim 1, wherein at least one of the multiple sets of processing parameters or the one or more data parameters are weighted based on a corresponding usage of infrastructure resources associated with the at least one of the multiple sets of processing parameters or the one or more data parameters.

7. A method of dynamically configuring a data processing system, comprising:
identifying one or more real-time data parameters associated with a data stream;
determining, using at least one of a machine learning model or a set of rules, and based on the real-time data parameters, a set of optimal processing parameters associated with processing the data stream;
configuring a data processing device with the set of optimal processing parameters; and
processing the data stream using the data processing device and based on the set of optimal processing parameters.

8. The method of claim 7, wherein determining the set of optimal processing parameters includes determining the set of optimal processing parameters using the machine learning model, and
wherein the method further comprises training the machine learning model based on multiple sets of processing parameters and one or more data parameters associated with the multiple sets of processing parameters.

9. The method of claim 8, wherein the machine learning model is associated with one of a multi-class machine learning model or a multi-label machine learning model.

10. The method of claim 8, wherein at least one of the multiple sets of processing parameters or the one or more data parameters are associated with curated data.

11. The method of claim 8, wherein at least one of the multiple sets of processing parameters or the one or more data parameters are weighted based on a corresponding usage of infrastructure resources associated with the at least one of the multiple sets of processing parameters or the one or more data parameters.

12. The method of claim 7, wherein determining the set of optimal processing parameters includes determining the set of optimal processing parameters using the set of rules, and
wherein the set of rules indicates a corresponding set of processing parameters for each of multiple candidate sets of one or more data parameters.

13. The method of claim 7, wherein the one or more real-time data parameters includes one or more of:
an incoming stream size parameter,
a number of stream partitions parameter,
a data distribution among stream partitions parameter,
a publishing pattern parameter,
a presence of consumer lag parameter,
a data type parameter,
a type of application parameter,
a data processing latency parameter,
a central processing unit (CPU) and/or memory utilization for consumer nodes parameter,
a CPU and/or memory utilization for processor nodes parameter,
a relevant percentage parameter,
a time of day parameter, or
a day of a week parameter.

14. The method of claim 7, wherein the set of processing parameters includes one or more of:
a processing batch size parameter,
an application programming interface batch size parameter,
a number of stream consumer nodes parameter,
a number of stream processor nodes parameter,
a number of parallel connections between consumer pods and processor pods parameter,
a number of processor threads parameter,
a report monitoring metric granularity parameter,
a commit after count parameter,
a commit after time parameter,
a central processing unit (CPU) and/or memory allocation for consumer nodes parameter, or
a CPU and/or memory allocation for processor nodes parameter.

15. A non-transitory computer-readable medium storing a set of instructions, the set of instructions comprising:
one or more instructions that, when executed by one or more processors of a data processing device, cause the data processing device to:
identify one or more real-time data parameters associated with a data stream;
determine, using at least one of a machine learning model or a set of rules, and based on the real-time data parameters, a set of optimal processing parameters associated with processing the data stream;
configure the data processing device with the set of optimal processing parameters; and
process the data stream based on the set of optimal processing parameters.

16. The non-transitory computer-readable medium of claim 15, wherein the one or more instructions, that cause the data processing device to determine the set of optimal processing parameters, cause the data processing device to determine the set of optimal processing parameters using the machine learning model, and
wherein the one or more instructions further cause the data processing device to train the machine learning model based on multiple sets of processing parameters and one or more data parameters associated with the multiple sets of processing parameters.

17. The non-transitory computer-readable medium of claim 16, wherein the machine learning model is associated with one of a multi-class machine learning model or a multi-label machine learning model.

18. The non-transitory computer-readable medium of claim 16, wherein at least one of the multiple sets of processing parameters or the one or more data parameters are associated with curated data.

19. The non-transitory computer-readable medium of claim 16, wherein at least one of the multiple sets of processing parameters or the one or more data parameters are weighted based on a corresponding usage of infrastructure resources associated with the at least one of the multiple sets of processing parameters or the one or more data parameters.

20. The non-transitory computer-readable medium of claim 15, wherein the one or more instructions, that cause the data processing device to determine the set of optimal processing parameters, cause the data processing device to determine the set of optimal processing parameters using the set of rules, and
wherein the set of rules indicates a corresponding set of processing parameters for each of multiple candidate sets of one or more data parameters.
